(19) United States
(12) Patent Application Publication
(10) Pub. No.: US 2024/0102679 A1
(43) Pub. Date: Mar. 28, 2024

(54) APPARATUSES, COMPUTER-IMPLEMENTED METHODS, AND COMPUTER PROGRAM PRODUCTS FOR BUILDING AUTOMATION BASED ON ENVIRONMENT INFERENCES

(71) Applicant: Honeywell International Inc., Charlotte, NC (US)

(72) Inventors: Joseph Steven MAJEWSKI, Huntington, NY (US); Rahul Jaikaran CHILLAR, Marietta, GA (US); Avi CHATTERJEE, Kolkata (IN)

(21) Appl. No.: 18/060,107

(22) Filed: Nov. 30, 2022

(30) Foreign Application Priority Data
Sep. 23, 2022 (IN) 202211054743

(51) Int. Cl. F24F 11/49; F24F 11/74

(52) U.S. Cl. CPC F24F 11/49; F24F 11/74

(57) ABSTRACT

The present disclosure provides embodiments for improved monitoring of building environments for building automation based on environment inferences and various aspects associated therewith. A method can include receiving, via a standalone sensing device positioned in a monitored building environment, real-time environmental sensor data. The method can include generating, for the monitored building environment and based on the real-time environmental sensor data, an environmental building inference indicative of a state of at least one of an occupancy of the monitored building environment, an asset within the monitored building environment, or an ambience of the monitored building environment. The method can include generating, for the monitored building environment based on the environmental building inference, a prescriptive building insight.

### CROSS-REFERENCE TO RELATED APPLICATIONS

This application claims priority to and the benefit of India Provisional Application No. 202211054743, filed Sep. 23, 2022, which is hereby incorporated herein by reference.

### TECHNOLOGICAL FIELD

Embodiments of the present disclosure generally relate to data collection, aggregation, analysis, prediction, and augmentation techniques for generating accurate real-world environment inferences, and specifically to improved sensing devices and sensor data analysis, prediction, and augmentation techniques for generating building insights to optimize building functions.

### BACKGROUND

Information management regarding an environment, operational aspects thereof, and/or related determinations is often attempted via any number of systems, processes, and/or users. In this regard, such information management often is segmented in a manner that requires external integration of these disparate systems, processes, and/or users to aggregate or make determinations regarding the totality of data associated with a particular environment. Further still, in circumstances where aggregation of such data is centralized, such aggregation often only provides insight at a particular time (and that can readily become outdated), is relevant to current owners and/or operators of an environment, and otherwise may not represent a transparent, up-to-date insight with respect to the particular environment.

Applicant has discovered problems with current implementations for managing data associated with a building environment and deriving data therefrom. Through applied effort, ingenuity, and innovation, Applicant has solved many of these identified problems by developing embodied in the present disclosure, which are described in detail below.

### BRIEF SUMMARY

In general, embodiments of the present disclosure provide for improved data collection, aggregation, analysis, prediction, and augmentation devices and techniques for a monitored building environment. Other implementations for improved monitored building environment data collection and handling will be, or will become, apparent to one with skill in the art upon examination of the following figures and detailed description. It is intended that all such additional implementations be included within this description be within the scope of the disclosure, and be protected by the following claims.

In accordance with a first aspect of the present disclosure, a computer-implemented method is provided. The computer-implemented method is implementable via any of a myriad of hardware, software, firmware, and/or a combination thereof, as described herein. In at least one example computer-implemented method, the example method includes, at a device with one or more processors and a memory. The method includes receiving, via a standalone sensing device positioned in a monitored building environment, real-time environmental sensor data. The method includes generating, for the monitored building environment and based on the real-time environmental sensor data, an environmental building inference indicative of a state of at least one of an occupancy of the monitored building environment, an asset within the monitored building environment, or an ambience of the monitored building environment. The method includes generating, for the monitored building environment based on the environmental building inference, a prescriptive building insight.

Additionally or alternatively, in some embodiments of the example method, the real-time environmental sensor data comprises: (i) vibration sensor data, (ii) acoustic sensor data, (iii) temperature sensor data, (iv) revolutions-per-minute (RPM) sensor data; (v) humidity sensor data, (vi) magnetic flux sensor data, (vii) air quality sensor data, (viii) lighting sensor data, (ix) gas detection sensor data, (x) occupancy sensor data, (xi) ingress sensor data, (xii) infrared sensor data, and (xiii) radio frequency data.

Additionally or alternatively, in some such embodiments of the example method, the example method further includes providing, to a monitored building device separate from the standalone sensing device, one or more instructions for implementing the prescriptive building insight.

Additionally or alternatively, in some embodiments of the example method, the environmental building inference comprises occupancy data indicative of a number of one or more active entities within the monitored building environment and one or more entity attributes for at least one active entity of the one or more active entities.

Additionally or alternatively, in some embodiments of the example method, the example method further includes determining the occupancy data based on at least one of occupancy sensor data, air quality sensor data, ingress sensor data, radio frequency data, or infrared sensor data.

Additionally or alternatively, in some embodiments of the example method, the example method further includes determining the number of the one or more active entities within the monitored building environment based on an aggregation of: (i) a first occupancy prediction based on proximity data associated with the occupancy sensor data, (ii) a second occupancy prediction based on one or more cellular networking signals of the radio frequency data, and (iii) a third occupancy prediction based on a CO2 level associated with the air quality sensor data.

Additionally or alternatively, in some embodiments of the example method, the prescriptive building insight comprises an occupancy-based energy insight, based on the occupancy data, that is indicative of one or more energy saving measures for the monitored building environment.

Additionally or alternatively, in some embodiments of the example method, the occupancy-based energy insight includes a climate insight based on the occupancy data, humidity sensor data, and temperature sensor data.

Additionally or alternatively, in some embodiments of the example method, the occupancy-based energy insight includes a lighting insight based on the occupancy data and lighting sensor data.

Additionally or alternatively, in some embodiments of the example method, the one or more entity attributes for the at least one active entity is indicative of an internal body temperature for the at least one active entity and wherein the prescriptive building insight comprise an optimized environment temperature based on the internal body temperature for the at least one active entity.

Additionally or alternatively, in some embodiments of the example method, the environmental building inference comprises asset data indicative of one or more asset attributes for at least one building asset within the monitored building environment, wherein the one or more asset attributes are indicative of an operability of the at least one building asset.

Additionally or alternatively, in some embodiments of the example method, the example method further includes determining the asset data based on vibration sensor data, revolutions-per-minute (RPM) sensor data, and acoustic sensor data.

Additionally or alternatively, in some embodiments of the example method, the prescriptive building insight comprises an asset value insight, based on the asset data, that is indicative of a predictive maintenance for the at least one building asset within the monitored building environment.

Additionally or alternatively, in some embodiments of the example method, the environmental building inference comprises ambient data indicative of one or more ambient attributes for the monitored building environment, the one or more ambient attributes indicative of at least one of an air quality, magnetic flux, or presence of gas within the monitored building environment.

Additionally or alternatively, in some embodiments of the example method, the example method further includes determining the ambient data based on gas detection sensor data, air quality sensor data, and magnetic flux sensor data.

Additionally or alternatively, in some embodiments of the example method, the prescriptive building insight comprises an ambient insight, based on the ambient data, that includes an environmental quality insight and a quality measure for optimizing the environmental quality insight.

In accordance with yet another aspect of the present disclosure, a system is provided. The system includes any number of specially configured computing devices, as described herein. In one example embodiment system, the example system includes a standalone sensing device for generating environmental sensor data, one or more processors, and a memory including computer program code stored thereon that, in execution with the one or more processors, is configured to perform any one of the example operations described herein. The operations include receiving, via the standalone sensing device positioned in a monitored building environment, real-time environmental sensor data. The operations include generating, for the monitored building environment and based on the real-time environmental sensor data, an environmental building inference indicative of a state of at least one of an occupancy of the monitored building environment, an asset within the monitored building environment, or an ambience of the monitored building environment. The operations include generating, for the monitored building environment based on the environmental building inference, a prescriptive building insight.

Additionally or alternatively, in some embodiments of the example system, the standalone sensing device comprises a housing and a plurality of sensors disposed within the housing, wherein the plurality of sensors comprise one or more components of at least one of a: (i) vibration sensor; (ii) acoustic emission sensor; (iii) temperature sensor; (iv) revolutions-per-minute (RPM) sensor; (v) humidity sensor; (vi) magnetic flux sensor; (vii) indoor air quality (IAQ) sensor; (viii) lighting sensor; (ix) gas detection sensor; and (x) occupancy sensor.

Additionally or alternatively, in some embodiments of the example system, the standalone sensing device is magnetically affixed to at least one of: (i) a building asset position relative to a building asset within the monitored building environment, (ii) an ingress position relative to an ingress point to the monitored building environment, (iii) a boundary position relative to an exterior surface of the monitored building environment, or (iv) an interior position relative to an interior surface of the monitored building environment.

In accordance with yet another aspect of the present disclosure, a non-transitory computer-readable storage medium is provided. The non-transitory computer-readable storage medium includes computer program code for execution by one or more processors of a device. The computer program code is configured to, when executed by the one or more processors, cause the device to perform any one of the example methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a system that may be specially configured within which embodiments of the present disclosure may operate;

FIG. 2 depicts an example standalone sensing device in accordance with various embodiments of the present disclosure;

FIG. 3 is an example device distribution of environment monitoring sensors within a monitored building environment in accordance with various embodiments of the present disclosure;

FIG. 4 illustrates a block diagram of an example apparatus that may be specially configured in accordance with at least some example embodiments of the present disclosure;

FIG. 5 is a flowchart diagram of an example process for generating a prescriptive building insight for a monitored building environment in accordance with some embodiments discussed herein;

FIG. 6 is a dataflow diagram for occupancy-based intelligence based on building monitoring data in accordance with some embodiments discussed herein;

FIG. 7 is an operational example of occupancy-based intelligence based on building monitoring data in accordance with some embodiments discussed herein; and

FIG. 8 is another operational example of the of occupancy-based intelligence based on building monitoring data in accordance with some embodiments discussed herein.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

Various users, businesses, and other entities control, own, operate, and/or are otherwise associated with various monitored building environment(s). For example, in some circumstances, a particular entity owns or otherwise controls one or more building(s) utilized for any of a myriad of purposes (e.g., residential buildings, office buildings, commercial stores of various types, etc.). Often, an entity performs any of a number of processes to individually collect data from each of a plurality of disparate devices to make informed decisions for a monitored building environment. Traditionally, each device within a monitored building environment can include a limited set of sensors that are directly related to the functioning of the device. As an example, a thermostat can have a temperature sensor to provide temperature feedback and control an ambient temperature within the monitored building environment based on the temperature feedback. In conventional systems, these devices do not have access to contextual data for optimizing their performance based on real-world environment inferences for the monitored building environment.

The present disclosure is directed to a feedback—feedforward system that utilizes compressive, holistic sensor data to make inferences for a monitored building environment and automate building functions to optimize environmental, energy, and safety metrics for the monitored building environment. In this manner, the present disclosure enables sustainable autonomous buildings.

Aspects of the present disclosure are directed to (i) a new standalone sensing device for obtaining independent, reliable, holistic, and contextual information for a monitored building environment and is independent from existing building devices within the environment, and (ii) data analysis, aggregation, and augmentation techniques for processing disparate sensor data from a plurality of different sensor modalities to generate actionable prescriptive building insights.

Traditionally, different aspects of a building environment are individually monitored by building devices configured and placed within the building environment for a functional purpose. As an example, a conventional thermostat can monitor a temperature of a building environment to control the functions of a heating, ventilation, and air conditioning (HVAC) system in order to maintain a set temperature within the building environment. As another example, a conventional smart lock or an occupancy sensor can monitor for the presence of an active entity (e.g., a person, etc.) to control a locking mechanism for an ingress point to the building environment or perform another function. These devices include limited sensors that are narrowly tailored to the intended purpose of their respective device. In some cases, the sensors can be degraded, missing, or uncalibrated which can reduce the reliability of sensor measurements generated by such devices. Moreover, the oftentimes limited sensor capability of each individual device produces a limited representation of an environment without contextualization, which limits the capability and reliability of analysis performed using such data. Therefore, there is a technical problem with data analysis techniques that rely on conventional building sensors.

To address this technical problem, the present disclosure provides a standalone sensing device with sensing functionality for measuring a plurality of environmental parameters within a building environment. The standalone sensing device includes one device with a plurality of sensors for measuring the vibration, temperature, occupancy, air quality, acoustics, gas detection, and/or other parameters of a monitored building environment. The standalone sensing device is communicatively connected to a cloud platform configured to collect, aggregate, analyze, and augment environmental sensor data measured and provided by the standalone sensing device. This data can contextualize other information received by the cloud platform for the monitored building environment, which empowers the platform to make holistic inferences for the monitored building environment. These inferences can be utilized to generate prescriptive building insights for intelligently controlling one or more aspects of the monitored building environment as described herein.

### Definitions

In some embodiments, some of the operations above may be modified or further amplified. Furthermore, in some embodiments, additional optional operations may be included. Modifications, amplifications, or additions to the operations above may be performed in any order and in any combination.

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

The term “environment monitoring sensor” refers to a computing system configured to read and/or otherwise capture certain values associated with a building environment and/or operations associated therewith or therein. In some embodiments, the environment monitoring sensor is configured to capture data values representing one or more aspects of the environment around the sensor. Non-limiting examples of an environment monitoring sensor include, without limitation, various sensor types, including without limitation: IoT devices, connected equipment, utility systems, building security systems, building operational systems. One example environment monitoring sensor can include a standalone sensing device.

The term “standalone sensing device” refers to an individual computing device configured to read and/or otherwise capture a plurality of values associated with a building environment and/or operations associated therewith or therein. A standalone sensing device can be capable of receiving sensor data of a plurality of different data types from a plurality of different sensing modalities. This real-time environmental data can be indicative of a plurality of a different attributes of a building environment.

The standalone sensing device can include a single housing with a plurality of sensors disposed at least partially therein. The plurality of sensors can be a combination of different sensors that can include and/or be configured to perform the functions of, for example, one or more: (i) vibration sensor(s); (ii) acoustic emission sensor(s); (iii) temperature sensor(s); (iv) revolutions-per-minute (RPM) sensor(s); (v) humidity sensor(s); (vi) magnetic flux sensor(s); (vii) indoor air quality (IAQ) sensor(s); (viii) lighting sensor(s); (ix) gas detection sensor(s); (x) occupancy sensor(s), (xi) ingress sensor(s), and/or the like.

The vibration sensor(s), for example, can include circuitry (e.g., piezoelectric accelerometers) configured to sense vibrations. For example, the vibration sensor(s) can include three-axis accelerometers. Each vibration sensor can be configured to measure fluctuating accelerations or speeds of a surface at which the vibration sensor is physically disposed. The vibration sensor(s) can be configured to generate vibration sensor data indicative of vibration patterns within an environment. In some embodiments, the vibration sensor(s) can include ultrasound sensing circuitry that can measure vibration patterns of an object within a proximity to the object using ultrasound signals. Using ultrasound sensing circuitry can enable the measurement of vibrations without being physically in contact with an object.

The acoustic emission sensor(s) can include circuitry for measuring high-frequency energy signals within an environment. The acoustic emission sensor(s) can be configured to generate acoustic sensor data indicative of mechanical vibrations in a solid.

The temperature sensor(s) can include circuitry for measuring the temperature of an environment and converting the temperature into an electronic temperature record (e.g., temperature sensor data).

The RPM sensor(s) can include circuitry for converting mechanical motion into electrical pulses with or without direct contact when positioned near a turning rotor, gear, shaft, or other moving device. In some embodiments, the RPM sensor(s) can be configured to generate RPM sensor data indicative of an engine speed for an object.

The humidity sensor(s) can include circuitry for sensing, measuring, and reporting a relative humidity (RH) of air or determining an amount of water vapor present in gas mixture (air) or pure gas. The humidity sensor(s) can be configured to generate humidity sensor data indicative of the RH of air within an environment. In some cases, the humidity data can be indicative of a water adsorption and/or desorption process.

The magnetic flux sensor(s) can include circuitry (e.g., magnetic field sensors, etc.) for detecting and measuring magnetic fields (e.g., magnetometer, etc.) within an environment. The magnetic flux sensor(s) can be configured to generate magnetic sensor data indicative of a strength of a magnetic field within an environment.

The indoor air quality (IAQ) sensor(s) can include circuitry configured measure the attenuation of infrared radiation (of a specific wavelength) in the air. The IAQ sensors can include an infrared radiation source (bulb), a light-water tube, and an infrared detector with an appropriate filter. The IAQ sensor can be configured to generate IAQ sensor data. In some embodiments, the IAQ data can be indicative of a CO2 level within an environment.

The lighting sensor(s) can include circuitry (e.g., one or more photodiodes, photoresistors, phototransistors, photovoltaic light sensors, etc.) configured to sense the presence and magnitude of light within an environment. The lighting sensor(s) can be configured to generate lighting sensor data indicative of the presence of light within an environment.

The gas detection sensor(s) can include circuitry for detecting and identifying different types of gasses and/or measuring gas concentrations. The gas detection sensor(s) can be configured to generate gas sensor data indicative of the presence and/or concentration of gases within an environment.

The occupancy sensor(s) can include circuitry for detecting motion within an environment. In some embodiments, the occupancy sensor can include an infrared sensor. The occupancy sensor(s) can be configured to generate occupancy sensor data indicative of the presence of one or more objects within an environment.

The ingress sensor(s) can include circuitry for the detection of an entrance and/or exit of an object from an environment.

In some implementations, the standalone sensing device can further include one or more communication interfaces (e.g., Power over Ethernet (PoE), etc.) such as, for example, wireless and/or cellular communication interfaces. In addition, or alternatively, the standalone sensing device can include one or more infrared sensors for measuring temperatures (e.g., body temperature, object temperatures, etc.). The infrared sensors can include an additional set of sensors and/or be included in one or more other sensors of the standalone sensing device.

The term “sensor type” refers to a determinable electronically managed data value representing identifiable aspects of an environment monitoring sensor. Non-limiting examples of a sensor type include a sensor make and/or models of an environment monitoring sensor, and/or classification of environment monitoring sensor based on a general human-assigned classification. Non-limiting examples of a sensor type include, without limitation, an Internet-of-Things device, connected equipment, utility systems, building security systems, and building operational systems).

The term “monitored building environment” refers to a particular building or portion of a building for which operations data is monitored via one or more computing systems. In some embodiments, a monitored building environment is associated with and/or otherwise represented by a unique identifier or other data value that identifies the monitored building environment.

The term “building monitoring data” refers to electronically managed data representing functioning of one or more operations within a monitored building environment. Non-limiting examples of a building monitoring data include a level of an environmental condition within a monitored building environment, a data readout of a sensor and/or system within a monitored building environment, data values embodying functioning of a system within and/or associated with a monitored building environment, existence of the system in or associated with operations of a building environment, time a system in or associated with a monitored building environment is active or functional, and/or a consumption rate of a utility by or associated with a building environment. An example of building monitoring data include real-time environmental data.

The term “real-time environmental data” refers to contextual sensor data measured, generated, and provided by standalone sensing device(s) within a monitored building environment. The real-time environmental sensor data, for example, can include infrared data, ultrasound data, temperature data, etc. that can be utilized to augment data analysis for a monitored building environment. As an example, the real-time environmental sensor data can include an combination of: (i) vibration sensor data, (ii) acoustic sensor data, (iii) temperature sensor data, (iv) revolutions-per-minute (RPM) sensor data; (v) humidity sensor data, (vi) magnetic flux sensor data, (vii) air quality sensor data, (viii) lighting sensor data, (ix) gas detection sensor data, (x) occupancy sensor data, (xi) ingress sensor data, (xii) infrared sensor data, (xiii) radio frequency data, (ix) ingress sensor data, and/or the like. In this way, one standalone sensing device 200 can provide full building visibility across occupancy, energy, lighting, IAQ, vibration, acoustics, and safety.

The term “building environment type” refers to an electronically managed data value representing a classification of the monitored building environment and/or an association of the monitored building environment with a particular type of activity and/or business from a determinable set of possible categories. Non-limiting examples of a building environment type include a data value of a set of values representing Energy Information Administration (EIA) building types. In some embodiments, non-limiting examples of a building environment type include an assembly facility, an education facility, a public service facility, a cultural facility, a recreational facility, a housing facility, a retail facility, a health care facility, a hospitality facility, a lodging facility, an office facility, a research facility, a production facility, a storage facility, a water infrastructure facility, an energy infrastructure facility, a waste infrastructure facility, an information infrastructure facility, a transportation facility, a parking facility, and/or a mixed-use facility.

The term “cloud environment” with respect to one or more computing device(s) refers to a physical location of computing hardware that is separate from a physical location associated with other computing hardware, where the remote computing hardware is accessed utilizing one or more communications networks.

### Example Systems of the Disclosure

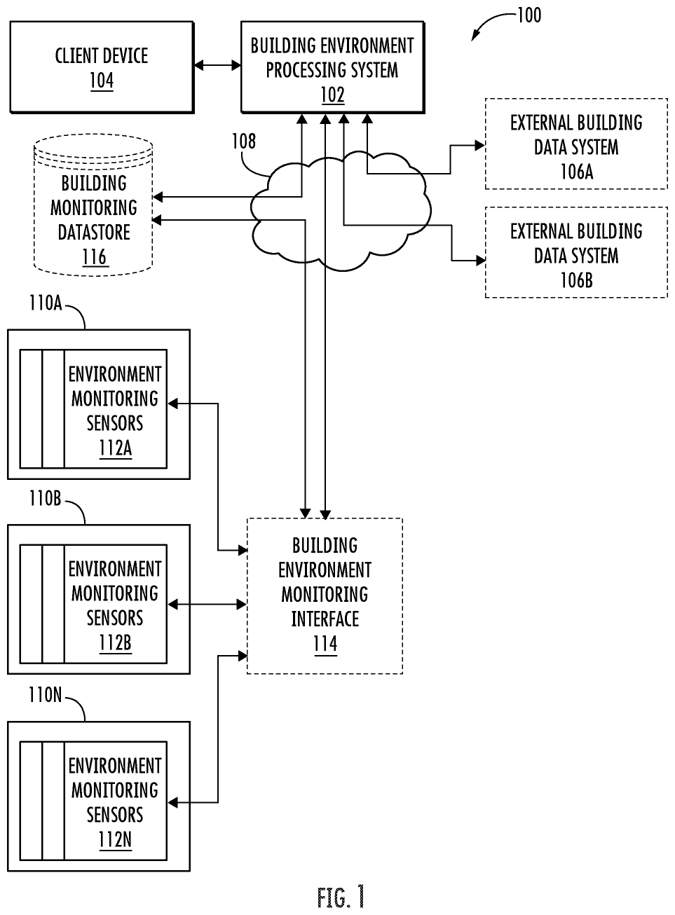

FIG. 1 illustrates a block diagram of a system that may be specially configured within which embodiments of the present disclosure may operate. Specifically, FIG. 1 depicts an example system 100. The example system 100 includes the client device 104, monitored building environment processing system 102, building monitoring datastore 116, external building data systems 106A and 106B (collectively “external building data system 106”), monitored building environment monitoring interface 114, and environment monitoring sensors 112A, 112B, and 112C (collectively—“environment monitoring sensors 112”). One or more client devices, such as the client device 104, monitored building environment processing system 102, external building data systems 106, building monitoring datastore 116, monitored building environment monitoring interface 114, and/or environment monitoring sensors 112, are each communicable with one or more other communication channels, for example embodied by the communications network 108. It should be appreciated that, in at least some embodiments, one or more component devices of the system 100 is/are optional. For example, in some embodiments, one or more optional component devices is not included. For purposes of illustration, optional components are depicted utilizing dashed (or “broken”) lines.

As illustrated, the system 100 includes a plurality of monitored building environments (collectively “monitored building environments 110”) within each of which one or more environment monitoring sensors 112 are positioned. Specifically, as depicted, the system 100 includes a first monitored building environment 110A including a first set of environment monitoring sensors 112A, a second monitored building environment 110B including a second set of environment monitoring sensors 112B, and a third monitored building environment 110C including a third set of environment monitoring sensors 112C. In this regard, each of the environment monitoring sensors 112 is configured to enable collection of building monitoring data associated with the corresponding monitored building environment of the monitored building environments 110. For example, each of the environment monitoring sensors 112 may intake data from within one of the monitored building environments 110 that represents building monitoring data and/or processes such data to determine building monitoring data for the associated monitored building environment.

The environment monitoring sensors 112 can include building devices configured to perform a function within a monitored building environment 110. Building devices, for example, can include IoT devices placed at one or more locations within the monitored building environment 110 and be communicatively connected to the monitored building environment processing system 102. Example building device(s) can include Internet provider device(s) such as routers, modems, range extenders, etc., security device(s) such as smart locks, access card machine(s), etc., connected climate control device(s), and/or the like. As described herein, such devices can have a limited, narrowly tailored, set of sensor(s) (if any) that can prevent each device from obtaining the contextual data useful for optimizing building device performance. To overcome these technical challenges with conventional IoT devices, the environment monitoring sensors 112 can include one or more standalone sensing device(s) distributed at various positions within the monitored building environment 110. The standalone sensing device(s) can include a plurality of sensor configured to obtain real-time environmental sensor data for augmenting the building monitoring data received from the building device(s) with contextual information.

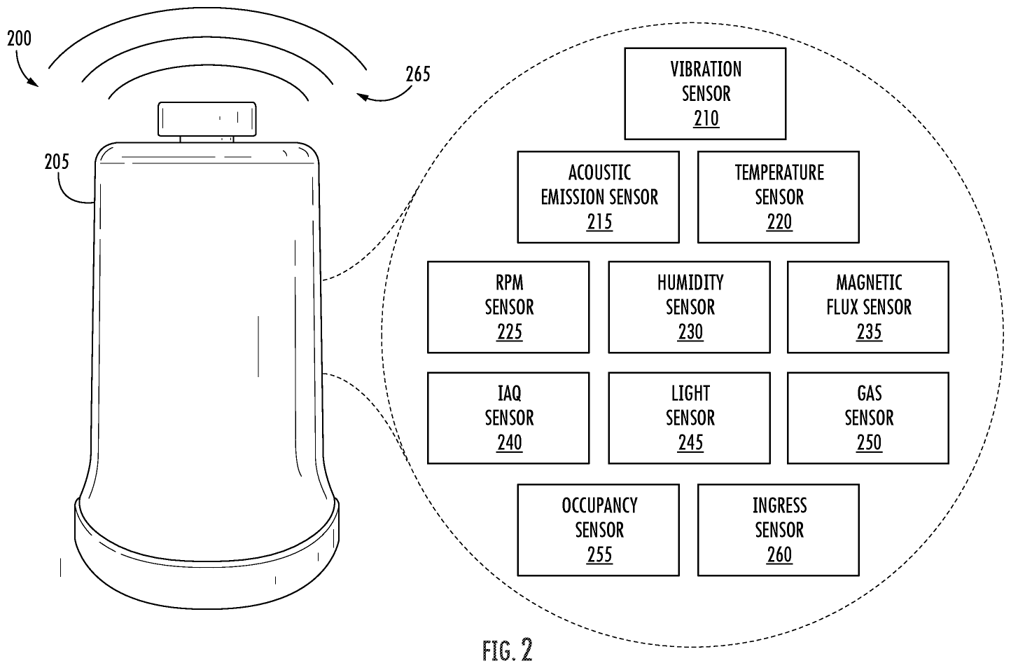

FIG. 2 depicts an example standalone sensing device 200 in accordance with various embodiments of the present disclosure. The standalone sensing device 200 can include a housing 205, within which a sensing circuitry of various sensor types are disposed. The housing 205 can include any rigid, non-rigid, or semi-rigid material (and/or combinations thereof). The sensing circuitry can be disposed at least partially within the housing 205. In some embodiments, the sensing circuitry can include can at least partially protrude from the housing 205.

The sensing circuitry for each individual standalone sensing device 200 can include a plurality of different sensors, each configured to obtain a different types of sensor data. The plurality of different sensors can form a sensor grouping assembled for obtaining holistic, contextual data for a monitored building environment regardless of the positioning of the standalone sensing device 200 within the monitored building environment. In this regard, the sensor grouping can include a universal grouping of sensors that can obtain relevant sensor data at any position (e.g., at an ingress point, ceiling/wall, corner, on a building asset, etc.) within the monitored building environment. In some embodiments, the sensor grouping can be dynamically configured based on the monitored building environment.

As one example, the plurality of different sensors within an individual standalone sensing device 200 can include a sensor grouping configured to measure a plurality of parameters (e.g., ten or more) within a monitored building environment. The sensor(s) can include any combination components from (i) vibration sensor(s) 210; (ii) acoustic emission sensor(s) 215; (iii) temperature sensor(s) 220; (iv) revolutions-per-minute (RPM) sensor(s) 225; (v) humidity sensor(s) 230; (vi) magnetic flux sensor(s) 235; (vii) indoor air quality (IAQ) sensor(s) 240; (viii) lighting sensor(s) 245; (ix) gas detection sensor(s) 250; (x) occupancy sensor(s) 255; or (xi) ingress sensor(s) 260.

The components of the vibration sensor(s) 210, for example, can include one or more accelerometers that sense vibration, the acoustic emission sensor(s) 215 can include circuitry for measuring high-frequency energy signals indicative of mechanical vibrations in a solid, the temperature sensor(s) 220 can include circuitry for converting an ambient temperature to a digital signal, the RPM sensors(s) 225 can include circuitry for converting mechanical motion into electric pulses (e.g., to measure revolutions of an engine, etc.), the humidity sensor(s) 230 can include circuitry for sensing the RH of air and/or an amount of water within a monitored building environment, the magnetic flux sensor(s) 235 can include circuitry (e.g., magnetometers, etc.)) for detecting and measuring magnetic fields, the indoor air quality (IAQ) sensor(s) 240 can include circuitry for measuring the attenuation of infrared radiation (of a specific wavelength) in the air, the lighting sensor(s) 245 can include circuitry configured to sense light, the gas detection sensor(s) 250 can include circuitry for the detection and identification of different types of gasses and measure gas concentrations, the occupancy sensor(s) 255 can include circuitry for the detection of motion, and the ingress sensor(s) 260 can include circuitry for the detection of an entrance and/or exit of an object from an environment.

The sensor grouping can enable the standalone sensing device 200 to measure, generate, and provide real-time environmental sensor data 265 indicative of a plurality of different attributes within a monitored building environment. The real-time environmental sensor data 265, for example, can include infrared data, ultrasound data, temperature data, etc. that can be utilized to augment data analysis for a monitored building environment. As an example, the real-time environmental sensor data 265 can include an combination of: (i) vibration sensor data, (ii) acoustic sensor data, (iii) temperature sensor data, (iv) revolutions-per-minute (RPM) sensor data; (v) humidity sensor data, (vi) magnetic flux sensor data, (vii) air quality sensor data, (viii) lighting sensor data, (ix) gas detection sensor data, (x) occupancy sensor data, (xi) ingress sensor data, (xii) infrared sensor data, (xiii) radio frequency data, (ix) ingress sensor data, and/or the like. In this way, one standalone sensing device 200 can provide full building visibility across occupancy, energy, lighting, IAQ, vibration, acoustics, and safety.

The standalone sensing device 200 can include an attachment mechanism for affixing the standalone sensing device 200 at one or more different positions within a monitored building environment. The attachment mechanism can include any type of attachment mechanism such as, for example, one or more clasps, adhesives, etc. In some embodiments, the attachment mechanism can include a magnetic device configured to adhere to a metal object. By way of example, the standalone sensing device 200 can be magnetically affixed to a sensing position within the building environment.

A plurality of standalone sensing devices 200 can be placed at different positions within a monitored building environment in a holistic sensor strategy to generate contextual, real-time environmental sensor data 265 for measuring a plurality of different parameter(s) (e.g., 3D vibration, acoustic emission, temperature, RPM, humidity, magnetic flux, IAQ, lighting, gas detection, occupancy, ingress, etc.) within the monitored building environment.

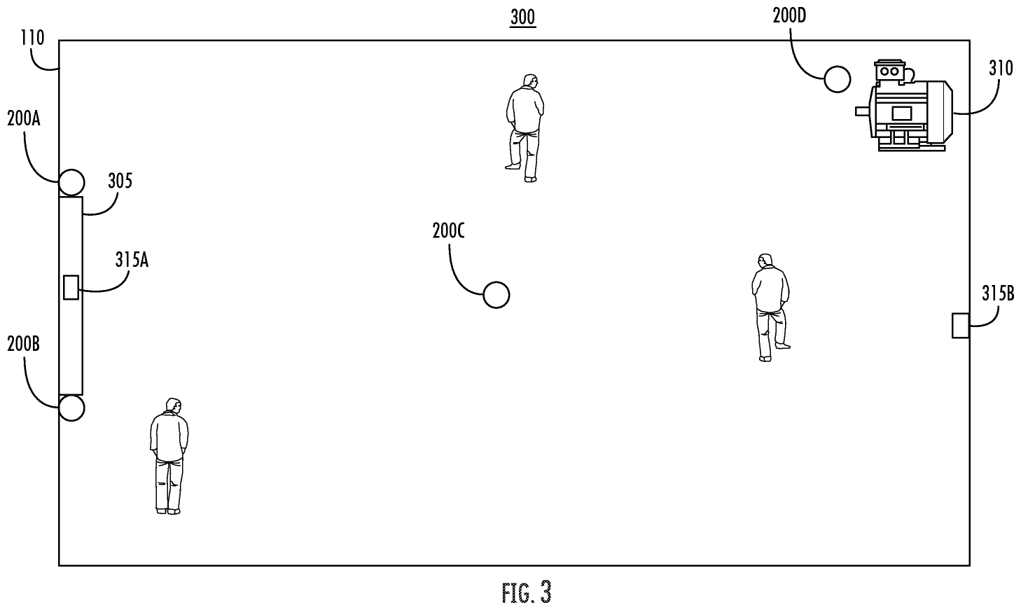

FIG. 3 is an example device distribution 300 of environment monitoring sensors 112 within a monitored building environment 110 in accordance with various embodiments of the present disclosure. The monitored building environment 110 includes an ingress point 315, one or more building asset(s) 310, and/or one or more boundaries.

In addition, the monitored building environment 110 includes a plurality of environment monitoring sensors 112 placed at various locations within the environment. The plurality of environment monitoring sensors 112 can include a plurality of standalone sensing devices 200A, 200B, 200C, 200C, 200D (collectively—standalone sensing devices 200) placed at various sensing positions to augment (and/or replace) a plurality of building device(s) 315A, 315B, 315C (collectively—building device(s) 315). The building device(s) 315, for example, can include Internet provider device(s) such as routers, modems, range extenders, etc., security device(s) such as smart locks, access card machine(s), etc., connected climate control device(s), and/or the like that can have a limited, narrowly tailored, set of sensor(s) (if any) for accomplishing a specific function within the monitored building environment 110.

As an example, the building device(s) 315 can include a security device 315A such as an access card machine placed at the ingress point 305 of the monitored building environment 110. The security device 315A can include IR sensors (or other security such biometric scanning sensors, etc.) configured to identify (and/or allow access to) an entity at the ingress point 305. Security device(s), such as the security device 315A, can be limited to such sensors that enable the performance of security functions within the monitored building environment and can lack contextual data for optimizing such functions.

As another example, the building device(s) 315 can include a connected climate control device 315B such as a connected thermostat for controlling a temperature of the monitored building environment 110. The climate control device 315B can include temperature sensors configured to measure a temperature within the monitored building environment 110. Climate control device(s), such as the climate control device 315B can be limited to such sensors that enable the performance of climate control functions within the monitored building environment 110 and can lack contextual data for optimizing such functions.

To overcome these technical challenges with conventional IoT devices, the standalone sensing device(s) 200 can be distributed at various positions within the monitored building environment 110 to obtain real-time environmental sensor data for augmenting the building monitoring data received from the building device(s) with contextual information. Each standalone sensing device(s) 200 can be positioned at a different sensing position within the monitored building environment 110. A sensing position, for example, can include at least one of: (i) a building asset position relative to the building asset 310 within the monitored building environment 110, (ii) an ingress position relative to an ingress point 305 to the monitored building environment 110, (iii) a boundary position relative to an exterior boundary of the monitored building environment, (iv) an interior position relative to an interior surface (e.g., a ceiling of the monitored building environment 110. A building asset 310, for example, can include machinery within a monitored building environment such as, for example, motor driven pumps, compressors, fans, etc.

In one example distribution, a first standalone sensing device 200A and a second standalone sensing device 200B can be positioned at an ingress position within a proximity to an ingress point 305 of the monitored building environment 110. A third standalone sensing device 200C can be positioned at an interior position (e.g., a centered position on a ceiling) of the monitored building environment 110. A fourth standalone sensing device 200D can be positioned at a building asset position within a proximity to a building asset 310 within the monitored building environment 110. Each of the standalone sensing devices 200 can include a same grouping of sensors such that each of the device can individually measure, generate, and provide holistic contextual data (e.g., real-time environmental sensor data) for the monitored building environment.

As described herein, the introduction of the standalone sensing device(s) 200 to the monitored building environment 110 can transform traditionally feedback system(s) (e.g., in which sensor measurements are only used to provide instant feedback on real-world conditions) to feedback and feedforward system(s) (e.g., in which instant feedback is generated, processed, and used for further control inputs).

Turning back to FIG. 1, the building monitoring data for each monitored building environment of the monitored building environments 110 is communicable to one or more other computing devices and/or stored by one or more computing devices. For example, in some embodiments, each of the environment monitoring sensors 112 communicates building monitoring data to the monitored building environment processing system 102 for processing. In this regard, in some embodiments, the building monitoring data is transmitted from each of the environment monitoring sensors 112 directly or indirectly to the monitored building environment processing system 102. For example, in some embodiments, the environment monitoring sensors 112 each transmit building monitoring data directly to the monitored building environment processing system 102. In other embodiments, the environment monitoring sensors 112 each transmit building monitoring data to the monitored building environment monitoring interface 114.

The monitored building environment monitoring interface 114 comprises one or more computing devices embodied in hardware, software, firmware, and/or a combination thereof, that aggregates building monitoring data for any number of monitored building environments 110. In some embodiments, the monitored building environment monitoring interface 114 stores such building monitoring data and/or preprocesses the collected building monitoring data for further transmittal and/or use. Additionally or alternatively, in some embodiments, the monitored building monitoring interface 114 is positioned within one or more of the monitored building environments 110. Alternatively or additionally, in other embodiments, the building monitoring interface 114 is positioned remote from each of the monitored building environments 110, for example in a centralized monitoring environment. In yet other embodiments, the monitored building environment monitoring interface 114 comprises one or more sub-interfaces within and/or proximate to each of the monitored building environments 110. For example, in an example context where the monitored building environment represents a particular building or a portion thereof, a particular sub-interface of the monitored building environment monitoring interface 114 includes one or more computing devices embodied in hardware, software, firmware, and/or a combination thereof, that is positioned within a data warehouse and/or office environment of the monitored building environment. In this regard, each of the sub-interfaces alone and/or in combination embody the monitored building environment monitoring interface 114 operating in conjunction. In some embodiments, the sub-interfaces can be and/or include building sensors for a monitored building environment. In some embodiments, a single monitored building environment monitoring interface 114 is located in a cloud environment with respect to one or more of the monitored building environments from which it receives data.

In yet some other embodiments, the environment monitoring sensors 112 provide building monitoring data for storage in the building monitoring datastore 116. For example, in some embodiments, each of the environment monitoring sensors 112 provide building monitoring data directly to the building monitoring datastore 116. In other embodiments, the building monitoring data is provided indirectly through the monitored building environment monitoring interface 114 and/or the monitored building environment processing system 102. The building monitoring datastore 116 may store the building monitoring data and/or information derived therefrom alone and/or stored together with data identifying the monitored building environment corresponding to the monitored building environment. In some embodiments, the building monitoring datastore 116 is positioned at a same location or proximate to the monitored building environment processing system 102, and/or is embodied by a cloud datastore remote from the monitored building environment processing system 102, monitored building environments 110, and/or monitored building environment monitoring interface 114. Alternatively or additionally, in some embodiments, the building monitoring datastore 116 is embodied by a plurality of sub-datastores, for example a datastore associated with each of the monitored building environments 110.

The monitored building environment processing system 102 receives building monitoring data in real-time for one or more of the monitored building environments 110. In some such embodiments, the monitored building environment processing system 102 processes the building monitoring data for any of a myriad of purposes, for example to generate one or more environmental building inferences, generate one or more prescriptive building insight, etc. described herein. In some embodiments, additionally or alternatively, the monitored building environment processing system 102 stores a historical record of the building monitoring data in one or more datastores for subsequent processing. For example, in some embodiments, the monitored building environment processing system 102 stores a historical record embodying the building monitoring data together with a timestamp indicating a datetime at which the building monitoring data was captured and/or received. In some embodiments, such historical records are stored in the monitored building environment processing system 102 and/or an associated building monitoring datastore 116. In some embodiments, the stored historical records embodying the building monitoring data are retrieved at a subsequent time for purposes of further processing, for example to generate one or more score(s) as described herein. In this regard, the historical records and/or received data may both represent objective data values received in real-time with respect to the time they were collected.

In some embodiments, the monitored building environment processing system 102 is configured to process external and/or third-party data not collected via the environment monitoring sensors 112 within the monitored building environments 110. For example, in some embodiments, the monitored building environment processing system 102 communicates with and/or processes data retrieved from one or more external building data systems, such as the external building data system 106A and/or 106B (collectively “external building data systems 106”). Each of the external building data systems 106 may include one or more computing devices embodied in hardware, software, firmware, and/or a combination thereof, that collects, aggregates, and/or stores such third-party data for processing. Such third-party data stored by one or more of the external building data systems 106 may include survey data associated with each of the monitored building environments 110, industry data associated with monitored building environments of various monitored building environment types, and/or the other data relevant to generating one or more prescriptive insights for a monitored building environment. In some embodiments, one or more of the external building data systems 106 is/are controlled, owned, and/or otherwise operated by the same entity than the entity that controls, owns, and/or otherwise operates the monitored building environment processing system 102 and/or the monitored building environments 110. In other embodiments, one or more of the external building data systems 106 is/are controlled, owned, and/or otherwise operated by a different entity than the entity that controls, owns, and/or otherwise operates the monitored building environment processing system 102 and/or the monitored building environments 110.

The monitored building environment processing system 102 is configured to process data from the one or more data sources, for example building monitored data obtained directly from the environment monitoring sensors 112 and/or the external building data systems 106. For example, in some embodiments, the monitored building environment processing system 102 processes data to generate an environmental building inference indicative of a state of at least one of an occupancy of the monitored building environment, an asset within the monitored building environment, or an ambience of the monitored building environment. In addition, or alternatively, the monitored building environment processing system 102 processes data to generate a prescriptive building insight such as, for example, an occupancy-based energy insight that is indicative of one or more energy saving measures for the monitored building environment, an asset value insight that is indicative of a predictive maintenance for at least one building asset within the building environment, an ambient insight that includes an environmental quality insight and a quality measure for optimizing the environmental quality insight, etc. as described herein. Additionally, or alternatively still, in some embodiments, the monitored building environment processing system 102 configures and/or provides data to cause rendering of one or more customized configured user interfaces, such as one or more dashboards as described herein.

In some embodiments, the monitored building environment processing system 102 includes one or more components embodied in a cloud environment with respect to each of the monitored building environments 110 and/or the client device 104. For example, in some embodiments, the monitored building environment processing system 102 includes at least one processor and/or at least one memory device positioned in one or more cloud environments. In this regard, in some embodiments, the monitored building environment processing system 102 includes such processor(s) and/or memory device(s) in a remote location from the monitored building environments 110, and/or in some embodiments from another, such that the cloud processor(s) and/or cloud memory device(s) are communicable over one or more communication networks. It should be appreciated that, in some embodiments, the devices located in the cloud environment are nevertheless configured to work in conjunction with one another to provide a consistent user experience and/or functionality access. In yet other embodiments, the monitored building environment processing system 102 is positioned in a monitored building environment, for example one or more of the monitored building environments 110. Alternatively or additionally, in some embodiments, each monitored building environment includes a monitored building environment processing system 102.

The client device 104 includes one or more computing devices embodied in hardware, software, firmware, and/or a combination thereof, that enables access to functionality provided by the monitored building environment processing system 102. In some embodiments, the client device 104 comprises a user device under the control of a particular user and/or entity that owns, operates, and/or otherwise desires to analyze aspects of the monitored building environments 110. For example, in some embodiments, the client device 104 is embodied by a user's mobile device accessing one or more software applications that provide access to the functionality of the monitored building environment processing system 102 as described herein. In some embodiments, the client device 104 is configured to execute a native software application that provides access to such functionality, for example an “app” installed to the client device 104 and executed by the user. In other embodiments, the client device 104 is configured to execute a web-based software application that provides access to such functionality via a browser application installed and/or executing on the client device 104. It should be appreciated that, in some embodiments, the client device 104 communicates with the monitored building environment processing system 102 over one or more communication networks to enable access to such functionality. For example, in some embodiments, the client device 104 communicates with the monitored building environment processing system 102 via the communications network 108 and/or another communications network to enable transmission of requests to the monitored building environment processing system 102, and/or response data from the monitored building environment processing system 102, to facilitate access to such functionality.

In some embodiments, the client device 104 communicates with the monitored building environment processing system 102 to establish an authenticated session that enables access to various functionality associated with the monitored building environment processing system 102. For example, in some embodiments, the client device 104 establishes an authenticated session with the monitored building environment processing system 102 to access data provided by certain building monitoring data associated with the particular monitored building environments of the monitored building environments 110 and/or particular external building data associated with the particular monitored building environments of the monitored building environments 110. In some embodiments, for example, a user utilizes the client device 104 to provide user authentication credentials linked to a particular user account maintained by the monitored building environment processing system 102. In this regard, in some embodiments, the user of the client device 104 authenticates a particular user account (e.g., associated with a provisioned user data object maintained by the monitored building environment processing system 102) to initiate an authenticated session associated with the particular user account, and thus accessing data associated with the particular user account. For example, in a context where monitored building environments 110A and 110B have been associated with a particular user account, and an authenticated session associated with the particular user account has been established via the client device 104, the user may utilize the client device 104 to access building monitoring data from the environment monitoring sensors 112A and 112B, third-party and/or external data provided by the external building data systems 106 that are associated with the monitored building environments 110A and/or 110B, and/or processed data or functionality associated therewith. Alternatively, in a context where third monitored building environment 110C has been associated with a particular user account, and an authenticated session associated with the particular user account has been established via the client device 104, the user may utilize the client device 104 to access building monitoring data from the environment monitoring sensors 112C, third-party and/or external data provided by the external building data systems 106 that are associated with the third monitored building environment 110C, and/or processed data or functionality associated therewith. In this regard, it should be appreciated that different users (e.g., who authenticate different user accounts associated with different user data objects) may be provided access to different data and/or functionality via the monitored building environment processing system 102.

In some embodiments, the client device 104 enables the user to access particular functionality and/or data via user interfaces rendered to the client device 104 via communication with the monitored building environment processing system 102. For example, in some embodiments, the monitored building environment processing system 102 communicates with the client device 104 to cause rendering of one or more user interface dashboards. In some embodiments, such user interface dashboard(s) is/are rendered including user interface elements that enable interaction with the data, for example sorting, filtering, and/or other view manipulation. Additionally or alternatively, in some embodiments, the user interface dashboard provides user interface elements for accessing additional functionality associated with the rendered data, for example to enable portfolio-level processing of such data associated with a plurality of associated monitored building environments.

The communications network 108 may embody any of a number of public and/or private networks enabling communication between various computing devices. For example, in some embodiments, the communications network 108 includes and/or is embodied by one or more network access device(s), cell tower(s), base station(s), network base station(s), wired and/or wireless connection tower(s), signal booster(s), signal propagation device(s), and/or the like. Each of the devices and/or systems described with respect to the system 100 may access the communications network 108 utilizing any of a myriad of transmission protocols and/or corresponding communications circuitry enabling transmission of specially configured transmissions based on the transmission protocol. A non-limiting example of the communications network 108 includes the Internet, and/or one or more hybrid networks enabling access to the Internet. It should be appreciated that, in some embodiments, the communications network 108 includes one or more sub-networks that facilitate communications between discrete devices of the system 100. For example, in some embodiments, the communications network 108 includes a sub-network that facilitates communication between the monitored building environment processing system 102 and the external building data systems 106 and/or building monitoring datastore 116, and a second sub-network that facilitates communication between the monitored building environment processing system 102 and the monitored building environment monitoring interface 114 and/or environment monitoring sensors 112. Each sub-network in some embodiments includes entirely distinct components. In other embodiments, one or more sub-networks include one or more shared components that facilitate such communications.

### Example Apparatuses of the Disclosure

The methods, apparatuses, systems, and computer program products of the present disclosure may be embodied by any variety of devices. For example, a method, apparatus, system, and computer program product of an example embodiment may be embodied by a fixed computing device, such as a personal computer, computing server, computing workstation, or a combination thereof. Further, an example embodiment may be embodied by any of a variety of mobile terminals, mobile telephones, smartphones, laptop computers, tablet computers, or any combination of the aforementioned devices.

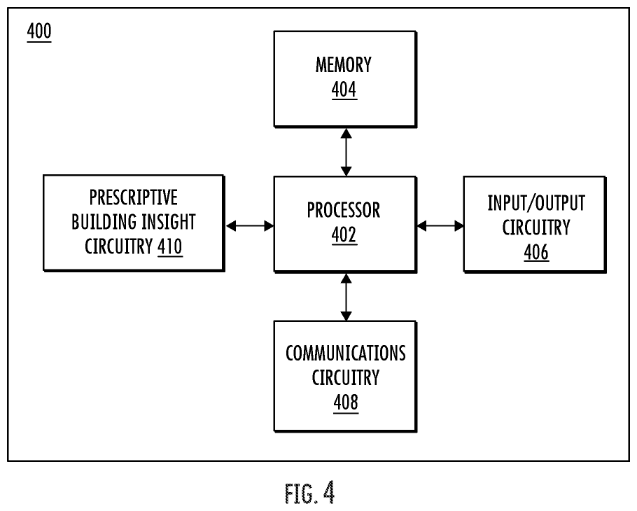

In at least one example embodiment, the monitored building environment processing system 102 is embodied by one or more computing systems, such as the apparatus 400 as shown in FIG. 4. The apparatus 400, as depicted, includes a processor, memory 404, input/output circuitry 406, communications circuitry 408, prescriptive building insight circuitry 410. Although the components are described with respect to functional limitations, it should be understood that the particular implementations necessarily include the use of particular hardware. It should also be understood that certain of the components described herein in some embodiments include similar or common hardware. For example, in some embodiments two sets of circuitry both leverage use of the same processor, network interface, storage medium, or the like to perform their associated functions, such that duplicate hardware is not required for each set of circuitry. The use of the term “circuitry” as used herein with respect to components of the apparatus 400 should therefore be understood to include particular hardware configured to perform the functions associated with the particular set of circuitry as described herein.

Additionally or alternatively, the term “circuitry” should be understood broadly to include hardware and, in some embodiments, software and/or firmware for configuring the hardware. For example, in some embodiments, “circuitry” refers to and/or includes processing circuitry, storage media, network interfaces, input/output devices, and the like. In some embodiments, other elements of the apparatus 400 provide or supplement the functionality of the particular circuitry. For example, in some embodiments the processor 402 provide processing functionality, the memory 404 provides storage functionality, the communications circuitry 408 provides network interface functionality, and the like, to one or more of the other sets of circuitry.

In some embodiments, the processor 402 (and/or co-processor or any other processing circuitry assisting or otherwise associated with the processor) is in communication with the memory 404 via a bus for passing information among components of the apparatus. The memory 404 is non-transitory and in some embodiments includes, for example, one or more volatile and/or non-volatile memories. In other words, for example in some embodiments, the memory embodies a non-transitory electronic storage device (e.g., a computer readable storage medium). In some embodiments, the memory 404 is configured to store information, data, content, applications, instructions, or the like, for enabling the apparatus 400 to carry out various functions in accordance with example embodiments of the present disclosure. In some embodiments, for example, the memory 404 embodies one or more databases for storing user data objects, electronic data objects, and/or other data associated therewith, and/or otherwise is configured to maintain such data objects for accessing and/or updating as described herein.

In various embodiments of the present disclosure, the processor 402 is embodied in any one of a myriad of ways and may, for example, include one or more processing devices configured to perform independently. Additionally or alternatively, the processor 402 may include one or more processors configured in tandem via a bus to enable independent execution of instructions, pipelining, and/or multithreading. The use of the terms “processor,” “processing module,” and “processing circuitry” may be understood to include a single-core processor, a multi-core processor, multiple processors internal to the apparatus, other central processing unit (“CPU”), microprocessor, integrated circuit, and/or remote or “cloud” processors.

In an example embodiment, the processor 402 is configured to execute computer-coded instructions stored in the memory 404 or otherwise accessible to the processor. Alternatively, or additionally, in some embodiments, the processor 402 is configured to execute hard-coded functionality. As such, whether configured by hardware or software means, or by a combination thereof, the processor 402 may represent an entity (e.g., physically embodied in circuitry) capable of performing operations according to an embodiment of the present disclosure while configured accordingly. Alternatively or additionally, in another example context, when the processor is embodied as an executor of software instructions, the instructions specifically configure the processor 402 to perform the algorithms and/or operations described herein when the instructions are executed.

As one example context, the processor 402 is configured to support monitored building environment data collection and/or processing functionality. In some such embodiments, for example, the processor 402 is configured to obtain real-time environmental sensor data from a plurality of standalone sensing devices positioned within a building environment, generate environmental building inferences based on the real-time environmental sensor data, generate a prescriptive building insight based on the environmental building inferences, etc.

In some embodiments, the apparatus 400 includes input/output circuitry 406 that, alone or in communication with processor 402, provides output to the user and/or receives indication(s) of user input. In some embodiments, the input/output circuitry 406 comprises one or more user interfaces, and/or includes a display to which user interface(s) may be rendered. In some embodiments, the input/output circuitry 406 comprises a web user interface, a mobile application, a desktop application, a linked or networked client device, and/or the like. In some embodiments, the input/output circuitry 406 also includes any of a number of peripherals, a keyboard, a mouse, a joystick, a touch screen, touch areas, soft keys, a microphone, a speaker, or other input/output mechanisms. In some such embodiments, the input/output mechanisms are configured to enable a user to provide data representing one or more user interaction(s) for processing by the apparatus 400. The processor and/or input/output circuitry 406 communicable with the processor, for example processor 402, is configured to control one or more functions of one or more user interface elements through computer program instructions (e.g., software and/or firmware) stored on a memory accessible to the processor (e.g., memory 404, and/or the like).

The communications circuitry 408 in embodied by any means such as a device or circuitry embodied in either hardware or a combination of hardware and software that is configured to receive and/or transmit data from/to a network and/or any other device, circuitry, or other module in communication with the apparatus 400. In this regard, the communications circuitry 408 includes, in some embodiments for example, at least a network interface for enabling communications with a wired or wireless communications network. For example, in some embodiments, the communications circuitry 408 includes one or more network interface cards, antennas, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s).

The prescriptive building insight circuitry 410 includes hardware, software, firmware, and/or a combination thereof, configured to support prescriptive building insight processing functionality associated with the monitored building environment processing system 102. The prescriptive building insight circuitry 410 in some embodiments utilizes processing circuitry, such as the processor 402, to perform one or more of these actions. In some embodiments, the prescriptive building insight circuitry 410 includes hardware, software, firmware, and/or a combination thereof, to receive, via a standalone sensing device positioned in a monitored building environment, real-time environmental sensor data; generate, for the monitored building environment and based on the real-time environmental sensor data, an environmental building inference indicative of a state of at least one of an occupancy of the monitored building environment, an asset within the monitored building environment, or an ambience of the monitored building environment; and/or generate, for the at least one monitored building environment based on the environmental building inference, a prescriptive building insight. It should be appreciated that, in some embodiments, the prescriptive building insight circuitry 410 includes or is embodied by a separate processor, specially configured field programmable gate array (FPGA), and/or a specially configured application-specific integrated circuit (ASIC).

### Example System Operations

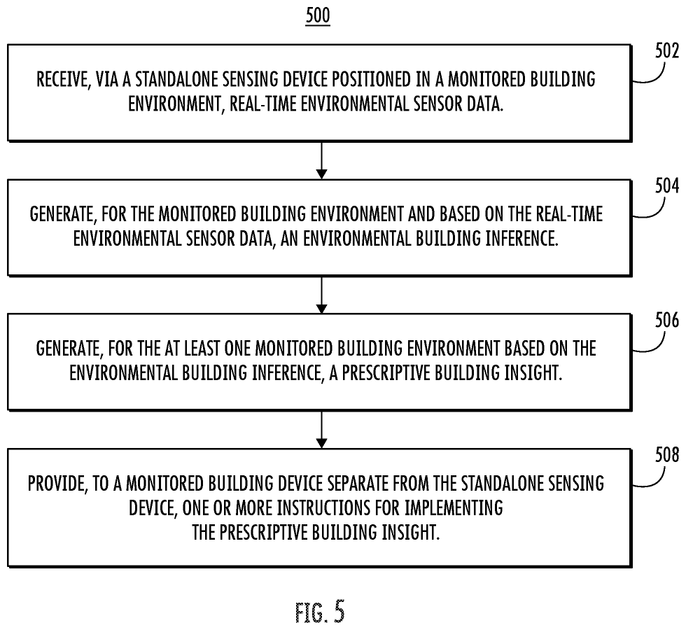

FIG. 5 is a flowchart diagram of an example process 500 for generating a prescriptive building insight for a monitored building environment in accordance with some embodiments discussed herein. Via the various steps/operations of the process 500, the prescriptive building insight circuitry 410 can generate a prescriptive building insight for a monitored building environment.

At step/operation 502, the process 500 can include receiving, via a standalone sensing device positioned in a monitored building environment, real-time environmental sensor data. For example, the prescriptive building insight circuitry 410 can receive, via the standalone sensing device positioned in the monitored building environment, real-time environmental sensor data. As described herein, the real-time sensor data can include at least one of: (i) vibration sensor data, (ii) acoustic sensor data, (iii) temperature sensor data, (iv) revolutions-per-minute (RPM) sensor data; (v) humidity sensor data, (vi) magnetic flux sensor data, (vii) air quality sensor data, (viii) lighting sensor data, (ix) gas detection sensor data, (x) occupancy sensor data, (xi) ingress sensor data, (xii) infrared sensor data, or (xiii) radio frequency data for the monitored building environment.

At step/operation 504, the process 500 can include generating, for the monitored building environment and based on the real-time environmental sensor data, an environmental building inference. For example, the prescriptive building insight circuitry 410 can generate, for the monitored building environment and based on the real-time environmental sensor data, the environmental building inference. The real-time environmental sensor data can be indicative of a state of at least one of an occupancy of the monitored building environment, an asset within the monitored building environment, or an ambience of the monitored building environment.

In some embodiments, environmental building inference(s) can be generated using one or more machine-learning techniques. By way of example, the prescriptive building insight circuitry 410 can include (and/or have access to) one or more inference machine-learning models previously trained to output environmental inferences for a monitored building environment based on real-time environmental sensor data. The inference machine-learning model(s) can include any type of machine-learning based model including one or more supervised, unsupervised, and/or reinforcement learning models. In some implementations, the inference machine-learning model(s) can include a machine-learning based prediction model configured to learn one or more associations between the real-time environmental sensor data and an environmental inference. By way of example, the inference machine-learning model(s) can include one or more neural networks (e.g., feedforward artificial neural networks, perceptron and multilayer perceptron neural networks, radial basis function artificial neural networks, recurrent neural networks, modular neural networks, etc.) trained using one or more supervised, unsupervised, and/or reinforcement training techniques based at least in part on a historical real-time environmental sensor data.

The environmental building inferences can include one or more occupancy inferences including predictions associated with the occupancy for the monitored building environment. The occupancy inferences, for example, can include occupancy data indicative of a number of one or more active entities (e.g., people, animals, etc.) within the monitored building environment and one or more active entity attributes for at least one of the one or more active entities. The occupancy data can be determined using one or more portions of the real-time environmental sensor data. For instance, the occupancy data can be determined based on occupancy sensor data, air quality sensor data, ingress sensor data, radio frequency data, or infrared sensor data, etc. By way of example, a number of the one or more active entities within the monitored building environment can be determined based on an aggregation of: (i) a triangulation of one or more wireless signals based on radio frequency data, (ii) a CO2 level based on the air quality sensor data, and/or (iii) proximity data based on occupancy sensor data.

Each type of sensor data can be utilized to generate an individual prediction for the occupancy of the monitored building environment.

For example, occupancy sensors can measure proximity data to determine the presence of one or more active entities within the monitored building environment. The occupancy sensors can generate a first occupancy prediction indicative of the presence of the one or more active entities within the monitored building environment based on the proximity data.

In addition, or alternatively, the radio frequency circuitry of the prescriptive building insight circuitry 410 can receive one or more wireless signals from a mobile device within the monitored building environment. The one or more wireless signals can include one or more radio frequency signals associated with the mobile device. For instance, the radio frequency signals can be and/or be associated with one or more cellular networking signal(s) and/or one or more WiFi signals emitted by the mobile device.

The prescriptive building insight circuitry 410 can triangulate the one or more cellular networking signal(s) to determine a location of a mobile device. In addition, or alternatively, the cellular networking signals can be triangulated by a third-party (e.g., cellular service provider, etc.) and provided to the prescriptive building insight circuitry 410. The prescriptive building insight circuitry 410 can determine a second occupancy prediction indicative a presence of an active entity within the monitored building environment based on a comparison between the triangulated location of the active entity and a footprint of the monitored building environment.

In addition, or alternatively, the prescriptive building insight circuitry 410 can obtain data indicative of an entity's access to a WiFi network. The data can be determine based on radio frequency data receive by the environmental sensing device. In addition, or alternatively, the data can be received from one or more building device(s) such as, for example, a wireless router, modem, etc. within the monitored building environment. The prescriptive building insight circuitry 410 can determine the second occupancy prediction indicative a presence of an active entity within the monitored building environment based on a number and/or identity of one or more mobile devices wirelessly connected to a WiFi network.

In some embodiments, the prescriptive building insight circuitry 410 can obtain air quality sensor data and determine a CO2 level based on the air quality data. The prescriptive building insight circuitry 410 can determine a third occupancy prediction indicative a presence of one or more active entities within the monitored building environment based on the CO2 level. By way of example, the air quality sensor data (and/or CO2 level) can be analyzed (e.g., using one or more machine-learned models, etc.) to predict a number of active entries within the monitored building environment based on historical correlations between an active entity's impact on CO2 levels within a building environment.

The prescriptive building insight circuitry 410 can aggregate the first, second, and third predictions to reliably predict a number of active entities within the monitored building environment in real-time. For instance, each prediction can be cross-checked with the other predictions to generate one reliable occupancy prediction based on a plurality of different sensor modalities within a single standalone sensing device. Unlike conventional occupancy predictions, the occupancy data described herein can aggregate information from a plurality of different sensor modalities to determine a number of occupants within a building environment as well as attributes for each of the occupants.

The occupancy data can be determined based on information obtained by one or more building devices and augmented with the real-time environmental sensor data (e.g., “building monitoring data”). For instance, ingress data from a security device can be augmented with the real-time environmental sensor data, etc.

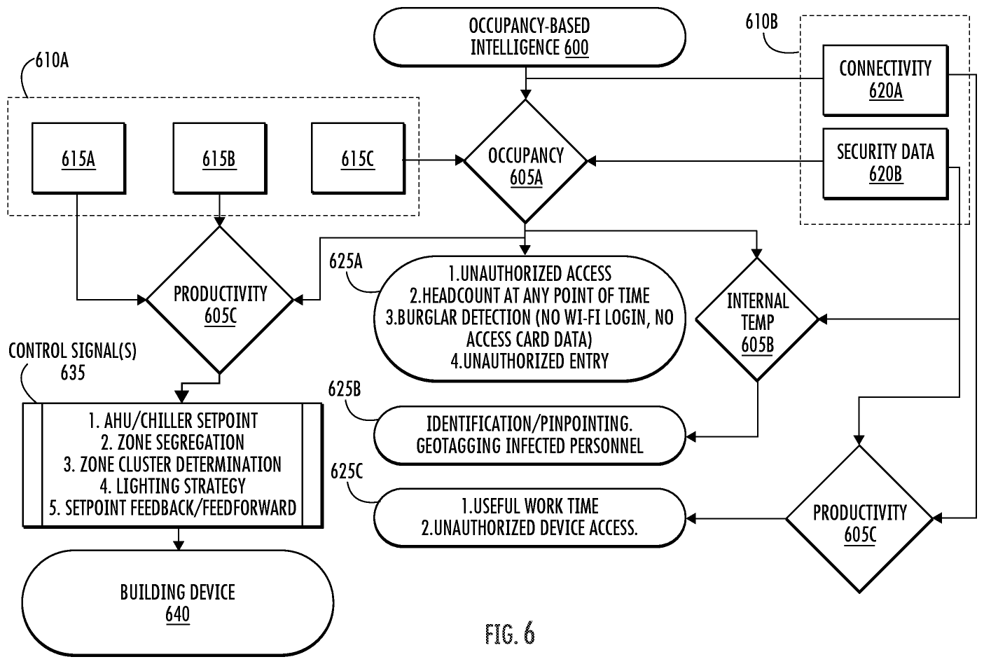

FIG. 6 is a dataflow diagram for occupancy-based intelligence 600 based on building monitoring data in accordance with some embodiments discussed herein. The occupancy-based intelligence 600 I configured to determine a plurality of occupancy inferences (collectively—occupancy inferences 605) based on the building monitoring data (collectively—building monitoring data 610). The example occupancy inferences 605 can include an occupancy prediction 605A comprising a predicted indication of a presence, number, and/or identification of one or more active entities within the monitored building environment. In addition, or alternatively, the example occupancy inferences 605 can include an internal temperature prediction 605B for one or more of the active entities within the monitored building environment. The internal temperature prediction 605B, for example, can be indicative of an internal body temperature for at least one active entity. As another example, the example occupancy inferences 605 can include a productivity prediction 605C for one or more of the active entities within the monitored building environment that is indicative of a predicted productivity of the active entities.

The occupancy inferences 605 can be based on the building monitoring data 610. The building monitoring data 610 can include real-time environmental sensor data from one or more standalone sensing device(s) and/or building data from one or more building device(s). As one example, the first building monitoring data 610A can include real-time environmental sensor data from a standalone sensing device. The real-time environmental senor data can include, for example, temperature sensor data 615A, light sensor data 615B, occupancy sensor data 615C, and/or any other data described herein with reference to the standalone sensing device(s). As one example, the second building monitoring data 610B can include sensor data from a building device. By way of example, the second building monitoring data 610B can include connectivity data 620A indicative of one or more active entities' access to a particular WiFi network, security data 620B indicative of a credentialled entry of one or more active entities (e.g., by scanning an access card, etc.).

The occupancy-based intelligence 600 can include the generation of a plurality of sub-analytics (collectively—sub-analytics 625) based on the occupancy inference(s) 605 and the building monitoring data 610.

By way of the example, the sub-analytics 625 can include building access analytics 625A based on the security data 620B and the occupancy prediction 605A. Example, sub-analytics 625A can include an indicative of unauthorized access (e.g., based on recorded entries and a number of occupants within the monitored building environment), a headcount at any point in time, crime (e.g., burglary, etc.) detection, and/or unauthorized access.

As another example, the sub-analytics 625 can include health analytics 625B based on the security data 620B and the occupancy prediction 605A. Example, sub-analytics 625B can include an identification/pinpointing of a specific active entity, geotagging an infected personnel (e.g., based on body temperature and active entity locations), etc.

As yet another example, the sub-analytics 625 can include productivity analytics 625C based on the connectivity data 620A and the occupancy prediction 605A. Example, sub-analytics 625C can include an indicative of useful work time (e.g., as indicated by an active entity's engagement with the internet) and/or unauthorized device access (e.g., based on a headcount and active entity engagement with the internet).

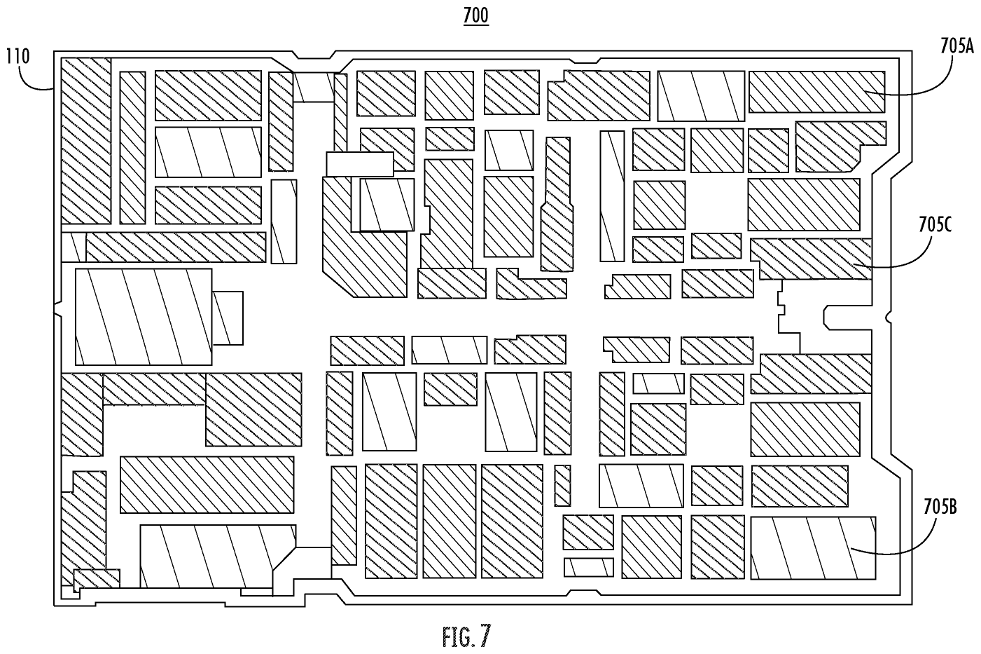

FIG. 7 is an operational example 700 of occupancy-based intelligence based on building monitoring data in accordance with some embodiments discussed herein. A monitored building environment 110 can include a plurality of different zone(s) (collectively—zone(s) 705) with one or more active entities within each zone. The occupancy data described herein can be leveraged to determine an individual occupancy prediction for each of the plurality of different zone(s) 705. In some embodiments, the occupancy prediction for each zone can be represented as a heat map in which a first zone 705 with a low occupancy prediction that is below a low threshold (e.g., zero active entities, etc.) can be represented by a first coloring (e.g., green, etc.) or weight, a third zone 705C with a high occupancy prediction that is above a high threshold (e.g., five or more, etc.) can be represented by a third coloring (e.g., red, etc.) or weight, and/or a second zone 705B with an intermediate occupancy prediction (e.g., between the low and high occupancy thresholds) can be represented by a second coloring (e.g., yellow, etc.) or weight.

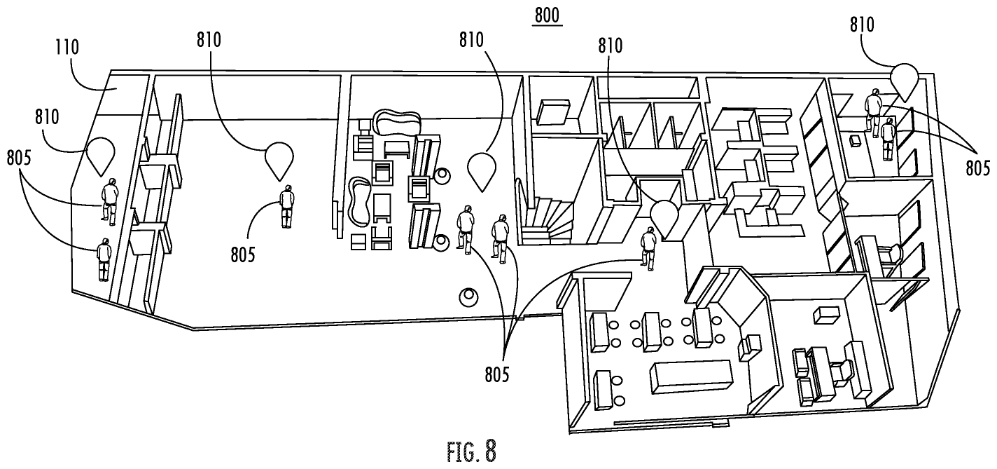

FIG. 8 is another operational example 800 of the of occupancy-based intelligence based on building monitoring data in accordance with some embodiments discussed herein. A monitored building environment 110 can include a plurality of active entities 805 within. The occupancy data described herein can be leveraged to determine an individual occupancy prediction for each of the active entities 805 within the monitored building environment 110. For instance, the occupancy prediction can be indicative of a relative location of each active entity 805 within a representation of the monitored building environment 110. In some embodiments, the occupancy prediction can include different attributes for each active entity such as, for example, internal temperatures, etc. In some embodiments, an attribute can include a connection attribute 810 indicating that a respective active entity is connected to a wireless network.

Turning back to FIG. 5, the environmental building inferences can include one or more asset inferences including predictions associated with the building assets within the monitored building environment. The asset inferences, for example, can include asset data indicative of one or more asset attributes for at least one building asset within the monitored building environment. By way of example, the one or more asset attributes can be indicative of an operability of the at least one building asset.

The asset data can be determined using one or more portions of the real-time environmental sensor data. For instance, the asset data can be determined based on vibration sensor data, revolutions-per-minute (RPM) sensor data, acoustic sensor data, and/or ultrasound sensor data. As one example, a vibration signature of a building asset can be measured using one or more vibration sensor data and/or ultrasound sensor data. The vibration signature can be analyzed (e.g., using one or more machine-learning based model(s), etc.) to determine an operability of the building asset.

As another example, the environmental building inferences can include one or more ambient inferences including predictions associated with an ambient environment within the monitored building environment. The ambient inferences, for example, can include ambient data indicative of one or more ambient attributes for the monitored building environment. The ambient attributes, for instance, can be indicative of at least one of an air quality, magnetic flux, presence of gas, etc. within the building environment. The ambient data can be determined using one or more portions of the real-time environmental sensor data. For instance, the ambient data can be determined based on gas detection sensor data, air quality sensor data, and magnetic flux sensor data, etc.

At step/operation 506, the process 500 can include generating, for the at least one monitored building environment based on the environmental building inference, a prescriptive building insight. For example, the prescriptive building insight circuitry 410 can generate, for the monitored building environment based on the environmental building inference, a prescriptive building insight. A prescriptive building insight can include an occupancy-based energy insight, an asset value insight, an ambient insight, and/or any other prescriptive measure for optimizing one or more aspects of a monitored building environment.

As one example, the prescriptive building insight can include an occupancy-based energy insight that is indicative of one or more energy saving measures for the monitored building environment. The occupancy-based energy insight can be based on the occupancy data, one or more sub-analytics derived thereof, and/or additional sensor data.

For example, the occupancy-based energy insight can include a climate insight based on the occupancy data, humidity sensor data, and temperature sensor data. The climate insight can be indicative of an optimized temperature range and/or humidity level for a monitored building environment based on the occupancy of the monitored building environment. For instance, the climate insight can allow for higher temperature range in response to a determination that a monitored building environment is not occupied.

In addition, or alternatively, the climate insight can be indicative of an optimized temperature range and/or humidity level for a monitored building environment based on one or more entity attributes for active entities within the monitored building environment. By way of example, the one or more entity attributes for at least one entity can be indicative of an internal body temperature for the at least one entity. In some embodiments, the prescriptive building insight can include an optimized environment temperature based on the internal body temperature for the at least one entity.

As another example, the occupancy-based energy insight can include a lighting insight based on the occupancy data and lighting sensor data. The lighting insight can be indicative of an optimized lighting range for a monitored building environment based on the occupancy of the monitored building environment. For instance, the lighting insight can allow for a higher lighting range in response to a high occupancy prediction for a monitored building environment, an intermediate lighting range in response to an intermediate occupancy prediction for a monitored building environment, and/or a low lighting range (e.g., by dimming lights, etc.) in response to a low occupancy prediction for a monitored building environment,

In some embodiments, the prescriptive building insight can include an asset value insight. The asset value insight can be indicative of a predicted lifetime of a building asset within the building environment based on the asset data (e.g., vibration signature, ultrasound data, etc.). In some embodiments, the asset value insight can include an indicative of predictive maintenance for the building asset. The predictive maintenance, for example, can include one or more inspections and/or repairs to extend the lifetime of the building asset based on the asset's vibration/ultrasound signatures.

In some embodiments, the prescriptive building insight can include an ambient insight. The ambient insight includes an environmental quality insight and/or a quality measure for optimizing the environmental quality insight, based on the ambient data. The ambient data, for example, can be indicative of an air quality, building health, and/or safety. The ambient insight can be indicative of a quality measure such as, for example, replacing an old air filter, etc. to increase the air quality, etc.

At step/operation 508, the process 500 can include providing, to a monitored building device separate from the standalone sensing devices, one or more instructions for implementing the prescriptive building insight. For example, the prescriptive building insight circuitry 410 can provide, to the monitored building device separate from the standalone sensing devices, the one or more instructions for implementing the prescriptive building insight. In this manner, the prescriptive building insight circuitry 410 can implement a feedback and feed forward system for automating one or more functions of a monitored building environment using a standalone sensing device separate from building devices.

FIG. 6 provides one example of occupancy-based building automation by leveraging building insights. As described herein, prescriptive building insights 630 can be generated based on occupancy inferences 605 and building monitoring data 610. The prescriptive building insights can include actionable input such as, for example, lighting actions, HVAC actions, etc. to improve the energy utilization of a monitored building environment. The prescriptive building insight circuitry 410 can generate one or more control instructions 635 for controlling building device 640 to implement the prescriptive building insight.

By way of example, the one or more instructions can be provided to an HVAC system to adjust the performance of the HVAC system (e.g., turn the HVAC system on/off, set a different temperature point, implement zone segregation strategies, determine zone clusters, etc.) based on the occupancy data. By way of example, the one or more instructions can cause the HVAC system to turn off to save energy in the event a monitored building environment is not occupied. As another example, the one or more instructions can be provided to a lighting system to adjust the performance of the lighting system (e.g., turn the lighting system on/off, set a different lighting magnitude, implement lighting strategies, etc.) based on the occupancy data. By way of example, the one or more instructions can cause the lighting system to turn off to save energy in the event a monitored building environment is not occupied.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
at a device with one or more processors and a memory:
receiving, via a standalone sensing device positioned in a monitored building environment, real-time environmental sensor data;
generating, for the monitored building environment and based on the real-time environmental sensor data, an environmental building inference indicative of a state of at least one of an occupancy of the monitored building environment, an asset within the monitored building environment, or an ambience of the monitored building environment; and
generating, for the monitored building environment based on the environmental building inference, a prescriptive building insight.

2. The method of claim 1, wherein the real-time environmental sensor data comprises: (i) vibration sensor data, (ii) acoustic sensor data, (iii) temperature sensor data, (iv) revolutions-per-minute (RPM) sensor data; (v) humidity sensor data, (vi) magnetic flux sensor data, (vii) air quality sensor data, (viii) lighting sensor data, (ix) gas detection sensor data, (x) occupancy sensor data, (xi) ingress sensor data, (xii) infrared sensor data, and (xiii) radio frequency data.

3. The method of claim 1, wherein the method further comprises:
providing, to a monitored building device separate from the standalone sensing device, one or more instructions for implementing the prescriptive building insight.

4. The method of claim 1, wherein the environmental building inference comprises occupancy data indicative of a number of one or more active entities within the monitored building environment and one or more entity attributes for at least one active entity of the one or more active entities.

5. The method of claim 4, further comprising:
determining the occupancy data based on at least one of occupancy sensor data, air quality sensor data, ingress sensor data, radio frequency data, or infrared sensor data.

6. The method of claim 5, further comprising:
determining the number of the one or more active entities within the monitored building environment based on an aggregation of:
(i) a first occupancy prediction based on proximity data associated with the occupancy sensor data,
(ii) a second occupancy prediction based on one or more cellular networking signals of the radio frequency data, and
(iii) a third occupancy prediction based on a CO2 level associated with the air quality sensor data.

7. The method of claim 4, wherein the prescriptive building insight comprises an occupancy-based energy insight, based on the occupancy data, that is indicative of one or more energy saving measures for the monitored building environment.

8. The method of claim 7, wherein the occupancy-based energy insight includes a climate insight based on the occupancy data, humidity sensor data, and temperature sensor data.

9. The method of claim 7, wherein the occupancy-based energy insight includes a lighting insight based on the occupancy data and lighting sensor data.

10. The method of claim 7, wherein the one or more entity attributes for the at least one active entity is indicative of an internal body temperature for the at least one active entity and wherein the prescriptive building insight comprise an optimized environment temperature based on the internal body temperature for the at least one active entity.

11. The method of claim 1, wherein the environmental building inference comprises asset data indicative of one or more asset attributes for at least one building asset within the monitored building environment, wherein the one or more asset attributes are indicative of an operability of the at least one building asset.

12. The method of claim 11, further comprises:
determining the asset data based on vibration sensor data, revolutions-per-minute (RPM) sensor data, and acoustic sensor data.

13. The method of claim 11, wherein the prescriptive building insight comprises an asset value insight, based on the asset data, that is indicative of a predictive maintenance for the at least one building asset within the monitored building environment.

14. The method of claim 1, wherein the environmental building inference comprises ambient data indicative of one or more ambient attributes for the monitored building environment, the one or more ambient attributes indicative of at least one of an air quality, magnetic flux, or presence of gas within the monitored building environment.

15. The method of claim 14, further comprises:
determining the ambient data based on gas detection sensor data, air quality sensor data, and magnetic flux sensor data.

16. The method of claim 14, wherein the prescriptive building insight comprises an ambient insight, based on the ambient data, that includes an environmental quality insight and a quality measure for optimizing the environmental quality insight.

17. A system comprising:
a standalone sensing device for generating environmental sensor data;
one or more processors;
a memory including computer program code stored thereon that, in execution with the one or more processors, is configured to:
receive, via the standalone sensing device positioned in a monitored building environment, real-time environmental sensor data;
generate, for the monitored building environment and based on the real-time environmental sensor data, an environmental building inference indicative of a state of at least one of an occupancy of the monitored building environment, an asset within the monitored building environment, or an ambience of the monitored building environment; and
generating, for the monitored building environment based on the environmental building inference, a prescriptive building insight.

18. The system of claim 17, wherein the standalone sensing device comprises a housing and a plurality of sensors disposed within the housing, wherein the plurality of sensors comprise one or more components of at least one of a: (i) vibration sensor; (ii) acoustic emission sensor; (iii) temperature sensor; (iv) revolutions-per-minute (RPM) sensor; (v) humidity sensor; (vi) magnetic flux sensor; (vii) indoor air quality (IAQ) sensor; (viii) lighting sensor; (ix) gas detection sensor; and (x) occupancy sensor.

19. The system of claim 18, wherein the standalone sensing device is magnetically affixed to at least one of: (i) a building asset position relative to a building asset within the monitored building environment, (ii) an ingress position relative to an ingress point to the monitored building environment, (iii) a boundary position relative to an exterior surface of the monitored building environment, or (iv) an interior position relative to an interior surface of the monitored building environment.

20. A non-transitory computer-readable storage medium comprising computer program code for execution by one or more processors of a device, the computer program code configured to, when executed by the one or more processors, cause the device to perform:
receive, via a standalone sensing device positioned in a monitored building environment, real-time environmental sensor data;
generate, for the monitored building environment and based on the real-time environmental sensor data, an environmental building inference indicative of a state of at least one of an occupancy of the monitored building environment, an asset within the monitored building environment, or an ambience of the monitored building environment; and
generating, for the monitored building environment based on the environmental building inference, a prescriptive building insight.
